(19) United States
(12) Patent Application Publication
(10) Pub. No.: US 2019/0329652 A1
(43) Pub. Date: Oct. 31, 2019

(54) DISPLAY DEVICE FOR VEHICLE

(71) Applicant: DENSO CORPORATION, Kariya-city, Aichi-pref. (JP)

(72) Inventor: Minoru SUMIYA, Kariya-city (JP)

(21) Appl. No.: 16/312,319

(22) PCT Filed: May 22, 2017
(86) PCT No.: PCT/JP2017/018958

§ 371 Date: Dec. 21, 2018

(30) Foreign Application Priority Data
Jun. 24, 2016 (JP) 2016-125934

(51) Int. Cl. B60K 35/00; G09G 3/36

(52) U.S. Cl. CPC B60K 35/00; G09G 2380/10; G09G 3/3648

(57) ABSTRACT

A display unit in a plate shape has a front surface configured to display an image. A circuit board is mounted with an electronic component. A protection plate in a plate shape is provided between the display unit and the circuit board and is affixed to the circuit board. The display unit includes multiple attachment portions projected from a rear surface on the opposite side of the front surface. The protection plate includes multiple contact portions, the separated portion, and multiple support portions. The contact portions are in contact with and affixed to the circuit board. The separated portion is separated from the circuit board. The support portions are in contact with and affixed to the attachment portions of the display unit. An electronic component is located between the circuit board and the separated portion.

### CROSS REFERENCE TO RELATED APPLICATION

This application is based on Japanese Patent Application No. 2016-125934 filed on Jun. 24, 2016, the disclosure of which is incorporated herein by reference.

### TECHNICAL FIELD

The present disclosure relates to a vehicle display device mountable on a vehicle and configured to display an image.

### BACKGROUND ART

Conventionally, a display device for a vehicle includes a display unit and a pointer which indicates a vehicle speed and an engine speed. The display unit indicates various kinds of vehicle information. The display unit is in a flat plate shape. A flexible printed wiring board (FPC) is extended from a back side of the display unit. The flexible printed wiring board is connected to a FPC connector of a circuit board, which is located on the back side of the display unit, and is electrically coupled to the circuit board (see, for example, Patent Document 1).

The display unit has been increased in size, and distortion would arise in a screen of the display unit due to vibration of the vehicle or the like.

Conventionally, in a configuration in which the display unit is affixed to the circuit board, a connecting portion, such as a boss for a screw, is provided on a side portion of the display unit to enable visual observation of the circuit board and the connecting portion. It is noted that, as the display unit is increased in size, the connecting portion, which is to be connected with the circuit board, is desirably located on the back side of the display unit to reduce the installation space of the connecting portion. It is further noted that, in a configuration, in which the connecting portion is located on the back side of the display unit, the connecting portion cannot be visually observed when the circuit board is mounted.

Therefore, electric contact would arise between an electronic component of the circuit board and the connecting portion.

### PRIOR TECHNICAL LITERATURE

### Patent Literature

PATENT LITERATURE 1: JP2015-075327A

### SUMMARY OF INVENTION

It is an object of the present disclosure to provide a display device for a vehicle which enables to protect an electronic element on a circuit board when a display unit is mounted and to increase its mechanical strength.

According to one aspect of the present disclosure, a vehicle display device is mountable on a vehicle and configured to display an image. The vehicle display device comprises a display unit in a plate shape and having a front surface configured to display an image. The vehicle display device further comprises a circuit board on which an electronic component is mounted. The vehicle display device further comprises a protection plate in plate shape. The protection plate is provided between the display unit and the circuit board and affixed to the circuit board. The display unit includes a plurality of attachment portions protruded from a rear surface on an opposite side of the front surface. The protection plate includes a plurality of contact portions, a separated portion, and a plurality of support portions. The contact portions are in contact with and affixed to the circuit board. The separated portion is separated from the circuit board. The support portions are in contact with and affixed to the attachment portions of the display unit. The electronic component is located between the circuit board and the separated portion.

### BRIEF DESCRIPTION OF THE DRAWINGS

The above and other objects, features and advantages of the present disclosure will become more apparent from the following detailed description made with reference to the accompanying drawings. In the drawings:

The above and other objects, features and advantages of the present disclosure will become more apparent from the following detailed description made with reference to the accompanying drawings. In the drawings:

FIG. 1 is a front view showing a display device for a vehicle;

FIG. 2 is a cross-sectional view taken along a line II-II in FIG. 1;

FIG. 3 is a front view showing a circuit board;

FIG. 4 is a cross-sectional view showing the display device for a vehicle;

FIG. 5 is a front view showing a protection plate;

FIG. 6 is a rear view showing an image display panel; and

FIG. 7 is a cross-sectional view showing the display device for a vehicle before being mounted.

### DESCRIPTION OF EMBODIMENTS

### First Embodiment

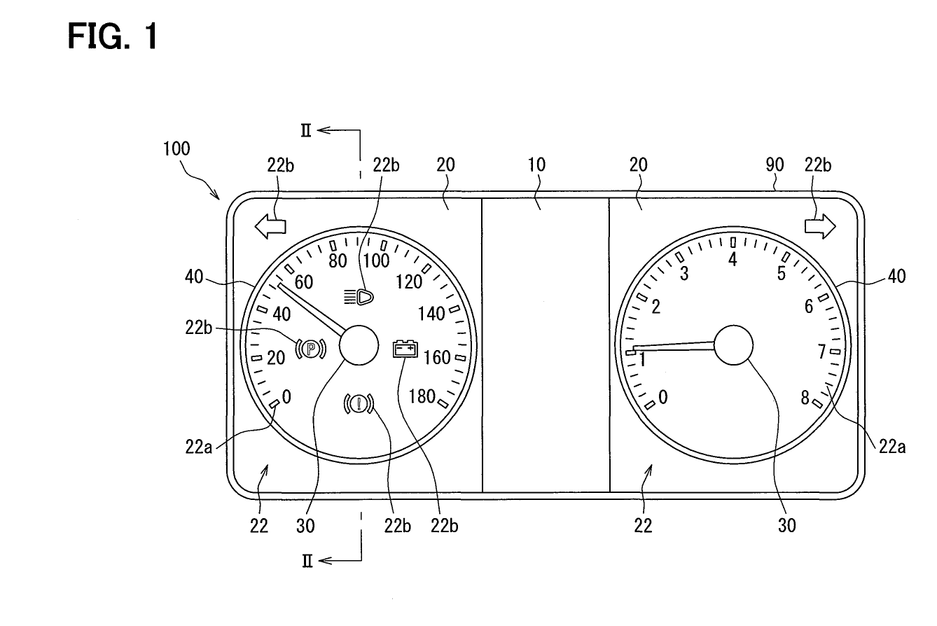

Hereinafter, a first embodiment of the present disclosure will be described with reference to FIGS. 1 to 7. A vehicle display device 100 according to the first embodiment is installed in a vehicle and mounted to an instrument panel. The instrument panel faces a seat on which a viewer is seated. As shown in FIG. 1, the vehicle display device 100 is a combination meter constructed by combining an analog display, in which a pointer 30 points an indicated object 22a, and a digital display, which is performed with an image display panel 10, to perform indication to a viewer.

The image display panel 10 is large enough to occupy one third of the surface of the vehicle display device 100 and is suitable for a large passenger car such as a truck. The present configuration enables a viewer, who is positioned on a viewer side with respect to the vehicle display device 100, to perceive displayed information. Examples of the displayed information include a state of the vehicle, such as a vehicle speed, an engine speed, a remaining fuel amount, a water temperature of engine cooling water, an electric current value of an electric motor, and an abnormality of the vehicle. Examples of the displayed information further include various kinds of information, such as alarm, road information, visibility assisting information, e-mail, and the like.

The vehicle display device 100 includes the image display panel 10, a display plate 20, the pointer 30, a decorative member 40, a case main body 50, and the like. The image display panel 10 is a display unit in a flat board shape having a surface. The image display panel 10 is a panel-like display element for indicating an image toward the viewer and is located substantially at the center of the apparatus. In the present embodiment, the image display panel 10 is, for example, an active matrix liquid crystal panel using a thin film transistor (TFT) and including a plurality of liquid crystal pixels arranged in two-dimensional direction.

The display plate 20 is also generally referred to as a face plate and has an opening, to which the image display panel 10 is mounted, at the center. The display plate 20 is formed by applying semi-translucent or light-shielding printing partially or entirely on the surface of a translucent base material, which is made of synthetic resin such as polycarbonate resin or acrylic resin, on the viewer side. The display plate 20 is in a flat plate shape. The printing may be substituted with painting. The display plate 20 is formed thin, and therefore, the display plate 20 is elastically deformable.

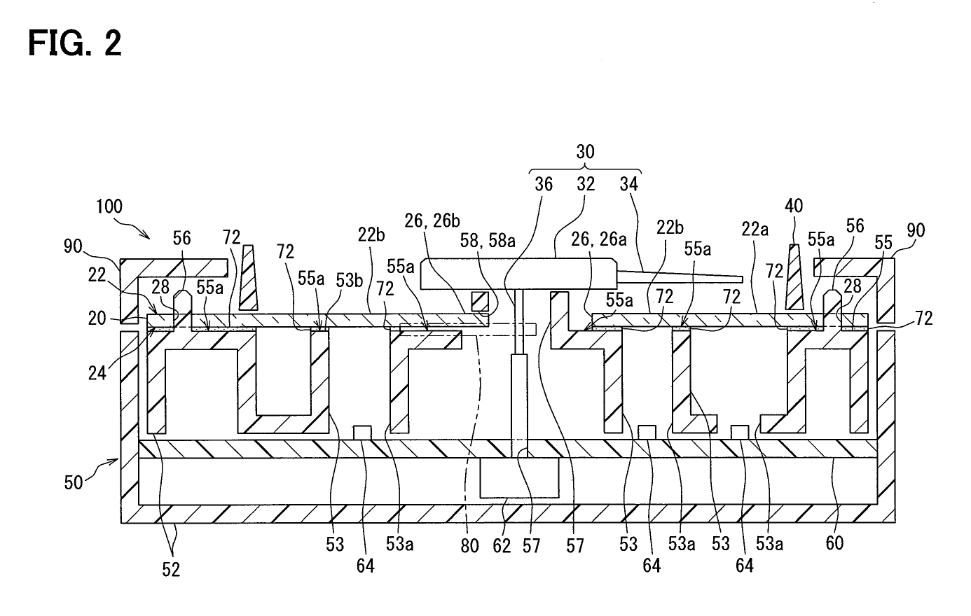

As shown also in FIG. 2, the display plate 20 has a display surface 22 and a rear surface 24 which is on the back side of a display surface 22. The display surface 22 of the display plate 20 faces the viewer, and indicated object 22a and 22b are formed by the printing. The indicated objects 22a and 22b include an indicated object 22a, which is pointed by the pointer 30, and an individual indicated object 22b, which performs indication individually from the pointer 30.

The indicated object 22a includes scale marks and letters, which are circumferentially arranged and are translucent. The indicated object 22a is pointed by the pointer 30 to indicate, for example, the speed of the vehicle, the number of engine revolutions, and the like. Multiple individual indicated objects 22b on the display plate 20 are translucent and include, for example, a mark indicating an operation state of a direction indicator, a mark indicating a direction of a head lamp, a mark indicating another warning, and the like. In FIG. 1, illustration of the individual indicated objects 22b is partially omitted. In this way, the display surface 22 performs indication to the viewer.

The display plate 20 has a through hole portion 26 surrounded by the indicated object 22a. The through hole portion 26 has a through hole 26a penetrating between the display surface 22 and the rear surface 24. A rotary shaft 36 of the pointer 30 is inserted through the through hole 26a. The through hole portion 26 includes a hooking claw 26b protruding from an edge of the through hole 26a toward the center of the through hole 26a. The through hole 26a is in a substantially circular shape in which its size in a protruding direction, in which the hooking claw 26b protrudes, is slightly larger than its size in a direction perpendicular to the protruding direction.

Further, in the present embodiment, the display plate 20 has a pair of pin holes 28 penetrating between the display surface 22 and the rear surface 24. One pair of pin holes 28 are formed on the outer peripheral portion of the display plate 20 on both sides interposing the through hole portion 26 therebetween.

Multiple pointers 30 are provided corresponding to the display plates 20. Particularly in this embodiment, one pointer 30 is provided on each display plate 20. Each pointer 30 includes a boss portion 32 and a needle-like portion 34, which extends from the boss portion 32. Each pointer 30 is located on the viewer side with respect to the display plate 20. Each pointer 30 is rotational around the rotary shaft 36, which is connected to the boss portion 32, and points the indicated object 22a by the needle-like portion 34.

The decorative member 40 is formed of, for example, a synthetic resin in an annular shape. The decorative member 40 is located on the viewer side relative to the display plate 20 and surrounds the indicated object 22a from the radially outside. The decorative member 40 is, for example, sandwiched between the case main body 50 and a cover member 90, which projects from an outer peripheral portion of the case main body 50 to the viewer side, and is retained relative to the case main body 50. Detailed illustration is omitted.

The case main body 50 is located on the opposite side of the display plate 20 from the pointer 30 and the decorative member 40. The case main body 50 includes a case 52, a circuit board 60, which is accommodated in the case 52, a stepping motor 62, a lighting element 64, and the like. The case 52 is made of a light-shielding synthetic resin such as polypropylene resin or ABS resin.

The circuit board 60 is formed of synthetic resin such as glass epoxy resin in a flat plate shape and is, for example, fastened to the case 52. The circuit board 60 is mounted with an electronic component 201, such as a control circuit, and further retains the image display panel 10, the stepping motor 62, the lighting element 64, and the like. The stepping motor 62 is controlled by the control circuit to rotate the pointer 30 via the rotary shaft 36.

The lighting element 64 is the electronic component such as a light emitting diode element. Multiple lighting elements 64 are mounted on the circuit board 60. Each lighting element 64 is connected to a power source through a control circuit, thereby to emit illumination light toward the display plate 20 on the viewer side. More specifically, the lighting elements 64 are arranged to the indicated objects 22a, 22b, respectively, and the lighting and extinction of each lighting element 64 are individually controlled by the control circuit.

Each indicated object 22a, 22b having the light-transmitting property forms a transmissive portion, which transmits illumination light from the corresponding lighting element 64 therethrough to perform indication. Therefore, when the corresponding lighting element 64 is lit, the indicated objects 22a, 22b are in an indication state. To the contrary, when the corresponding lighting element 64 is dimmed, the indicated objects 22a, 22b are in a non-indication state where visual recognition becomes difficult from the viewer side.

Hereinafter, one of the pair of the display plates 20, which is positioned on the left side as viewed from the viewer side, will be described. The same applies to the other display plate 20, and the description thereof will be omitted.

In order to implement the above-described individual lighting and extinguishing, the case 52 has multiple illuminating tubular portions 53 individually corresponding to the indicated objects 22a and 22b. The illuminating tubular portion 53 corresponding to the individual indicated object 22b is formed in a rectangular tube shape extending, for example, along the plate thickness direction of the display plate 20. The illuminating tubular portion 53 corresponding to the indicated object 22a is sandwiched between, for example, an annular outer cylindrical portion and an annular inner cylindrical portion and is in a donut-like cylindrical shape. The annular outer cylindrical portion and the annular inner cylindrical portion extend along the plate thickness direction of the display plate 20.

The lighting element 64 is located on the circuit board 60 in a region corresponding to the inside of the inner wall of the illuminating tubular portion 53. A light guiding hole 53a is formed in an end portion of the illuminating tubular portion 53 on the substrate side. The illuminating tubular portion 53 guides the illumination light from the lighting element 64 to the viewer side. A viewer side end portion 53b of the illuminating tubular portion 53 has a facing surface 55a in a smooth planar shape. The facing surface 55a is a part of a facing surface portion 55. The indicated objects 22a and 22b are arranged in a region surrounded by the viewer side end portion 53b.

The facing surface portion 55 of the case 52 of the case main body 50 faces the rear surface 24 of the display plate 20. The facing surface portion 55 is defined by the multiple facing surfaces 55a, which project toward the viewing side to the same height. The facing surface 55a extends in a smooth planar shape. A portion of the illuminating tubular portion 53, in which the facing surface 55a is not formed, is recessed toward the circuit board 60 to define an inner circumferential hole.

The case 52 has a pair of projected pins 56 provided on the outside of a portion of the display plate 20 in which the indicated object 22a is formed. The projected pins 56 are provided at locations corresponding to the respective pin holes 28 of the display plate 20. The projected pins 56 are projected from the facing surface 55a along the plate thickness direction toward the viewing side. The cross-sectional area of each of the projected pins 56 is smaller than the cross-sectional area of each of the pin holes 28. The protruding pins 56 are inserted in the pin holes 28, respectively.

As shown in FIGS. 1 and 2, each projected pin 56 and each pin hole 28 are covered by the cover member 90 from the viewer side and are concealed. A translucent member (omitted in FIGS. 1 and 2) is located on the viewer side of the cover member 90. The translucent member is formed of acrylic glass or the like.

The circuit board 60 and the case 52 form an inserted portion 57 through which the rotary shaft 36 of the pointer 30 is inserted. The inserted portion 57 of the case 52 is partially projected to the viewer side beyond the display plate 20 and is in a cylindrical shape smaller than the through hole 26a. A hooking hole 58a extends through a part of the inserted portion 57 of the case 52, which faces the hooking claw 26b. The hooking hole 58a extends from the outer periphery of the inserted portion 57 toward the inner periphery of the inserted portion 57. The hooking claw 26b is hooked on the interior of the hooking hole 58a, so that a hooking portion 58 is hooked on the through hole portion 26 of the case 52. Specifically, in the hooking portion 58, the inner peripheral wall of the hooking hole 58a covers the hooking claw 26b from the viewer side thereby to restrict the hooking claw 26b from moving toward the viewing side.

The display plate 20 is adhered to the case 52 of the case main body 50. The rear surface 24 of the display plate 20 and the facing surface portion 55 of the case main body 50 have an adhesive portion 72, which is adhered, and an adhesion restricted band 80, which is not adhered, therebetween. The adhesive portion 72 is partially located between the rear surface 24 and the facing surface portion 55 to adhere the display plate 20 to the case main body 50. The adhesive portion 72 is formed of adhesive having an adhesive property.

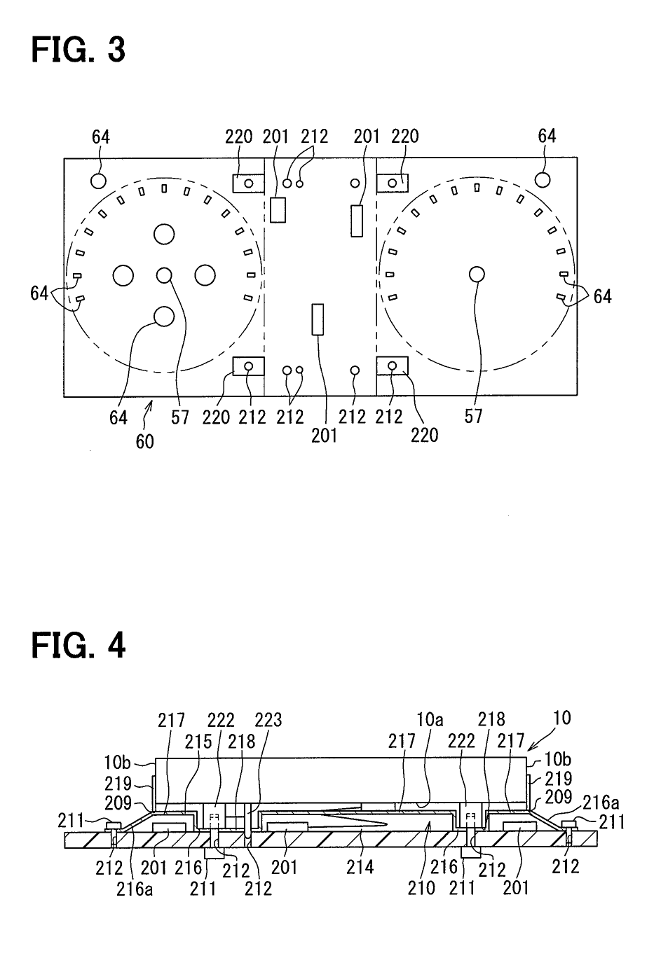

Subsequently, the arrangement of the image display panel 10 will be described. As shown in FIGS. 1 and 3, the image display panel 10 is located at the center of the vehicle display device 100 and has a size enough to occupy one-third of the surface of the vehicle display device 100. The image display panel 10 extends from the upper end to the lower end of the vehicle display device 100 in the vertical direction.

FIG. 3 shows the circuit board 60 in a simplified manner before the image display panel 10 is mounted thereon. The lighting element 64 is mounted on the circuit board 60. FIG. 3 shows two imaginary circles illustrated by imaginary lines correspondingly to regions in which the pointers 30 rotate, respectively. FIG. 3 show rectangles illustrated by imaginary lines and defining a region in which the vehicle display device 100 is located. The circuit board 60 is mounted with the electronic component 201, which is for controlling the image display panel 10 such as a display control IC.

As shown in FIG. 4, the image display panel 10 is mounted on the circuit board 60 via a protection plate 210. In other words, the protection plate 210 is provided between the circuit board 60 and the image display panel 10. As shown in FIG. 4, the protection plate 210 is in a plate shape and is affixed to the image display panel 10 and the circuit board 60 by using screws 211. The circuit board 60 has multiple through holes 212 in order to affix the protection plate 210 and the image display panel 10 thereto.

The protection plate 210 is in a size enough to cover the rear surface 10a and the outer periphery of the image display panel 10. The protection plate 210 is formed of metal, such as aluminum, having conductivity. The protection plate 210 is manufactured by, for example, press forming a metallic plate to deform the metallic plate in a desired shape. As shown in FIG. 7, the protection plate 210 is formed with multiple through holes 212.

The protection plate 210 is formed with an opening 213 at its center. As shown in FIG. 4, the image display panel 10 and the electronic component 201 are electrically connected to each other by using a connecting portion 214. The connecting portion 214 is, for example, an FPC. The connecting portion 214 is inserted through the opening 213. In other words, the opening 213 is formed in the circuit board 60 in order to insert the connecting portion 214 therethrough.

The protection plate 210 has a main body portion 215, contact portions 216, a separated portion 217, a support portion 218, and a wall portion 219. The contact portion 216 is a part of the protection plate 210 and is in contact with the circuit board 60. The contact portions 216 are provided on the main body portion 215 which is in a plate shape. The contact portions 216, which are provided at four corners among the contact portions 216, are referred to as leg portions 216a. As shown in FIG. 7, the leg portions 216a are projected toward the circuit board 60 to separate the main body portion 215 from the circuit board 60. The leg portions 216a are projected laterally. The through hole 212 is formed in the leg portion 216a, and the through hole 212 is also formed in the circuit board 60 at the corresponding position. The screw 211 is provided to pass through the through hole 212 of the leg portion 216a and the through hole 212 of the circuit board 60 for the leg portion 216a. The protection plate 210 is affixed to the circuit board 60 by using the screws 211. Grounding electrodes 220 are provided at portions where the leg portions 216a are in contact with the circuit board 60. In this way, the leg portions 216a are fixed by using the screws 211 in the state of being in contact with the grounding electrodes 220.

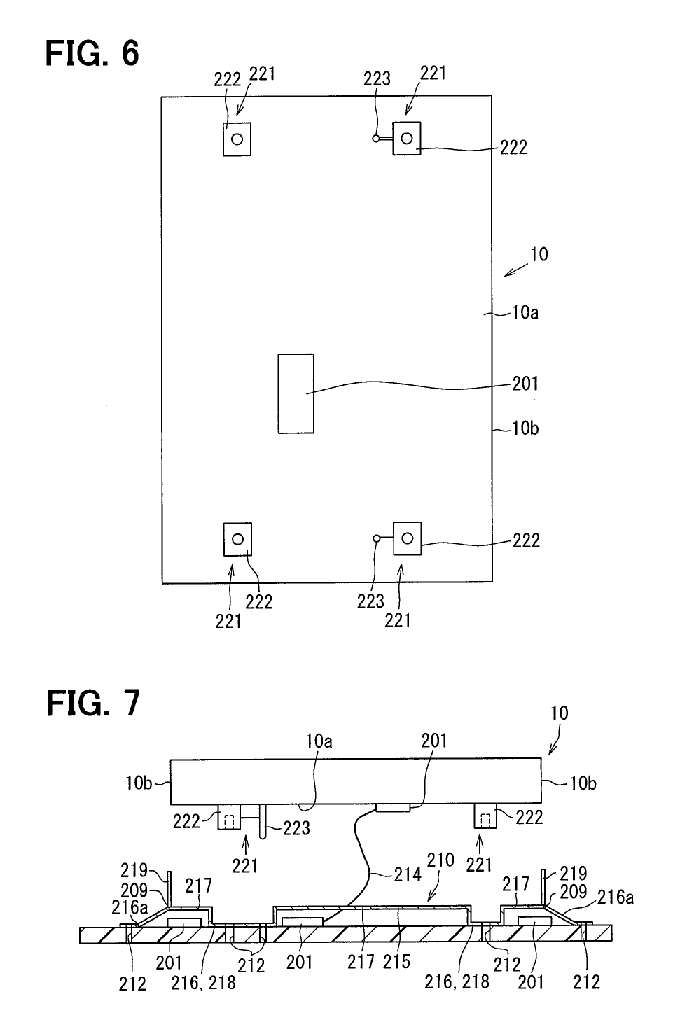

As shown in FIGS. 6 and 7, the image display panel 10 has multiple attachment portions 221 protruded from the rear surface 10a. As shown in FIG. 6, a recessed portion 222 or a projected portion 223 is formed in each of the two attachment portions 221 on the right side in FIG. 6 among the attachment portions 221. The recessed portion 222 is formed in each of the two attachment portions 221 on the left side in FIG. 6 which are the remaining two attachment portions 221. As shown in FIGS. 6 and 7, the projected portions 223 are formed integrally with the recessed portions 222, respectively. The present configuration enhances the strength of the projected portions 223.

As shown in FIG. 7, the contact portions 216 other than the leg portions 216a are formed at the center of the main body portion 215 and are recessed on the side of the circuit board 60. As shown in FIG. 4, the contact portions 216 other than the leg portions 216a are in contact with and affixed to the attachment portions 221 to function as support portions 218. The through holes 212 are formed in the leg portions 216a, respectively, and the through holes 212 are also formed in the circuit board 60 at the corresponding positions.

As shown in FIGS. 6 and 7, the attachment portions 221 and the support portions 218 are arranged to face each other. The recessed portions 222 of the attachment portions 221 are to be inserted with tip ends of the screws 211, respectively. The projected portions 223 are inserted into the through holes 212 of the protection plate 210 and the circuit board 60 to function as positioning pins for positioning.

Therefore, at the time of assembling, the projected portions 223 are first aligned to pass through the through holes 212 of the support portions 218 and the through holes 212 of the circuit board 60 for the support portions 218. In this way, the circuit board 60, the protection plate 210, and the image display panel 10 are positioned. The screws 211 are provided to extend through the through holes 212 of the support portions 218 and the through holes 212 of the circuit board 60 for the support portions 218. The tip ends of the screws 211 are positioned in the recessed portions 222, and the image display panel 10 is affixed to the circuit board 60 by using the screws 211.

In such an affixed state, the protection plate 210 has the separated portion 217 which is separated from the circuit board 60. The electronic component 201 is mounted between the circuit board 60 and the separated portion 217. So as to secure such a space for accommodating the electronic component 201, the shape and dimension of the leg portion 216a and the support portion 218 are determined.

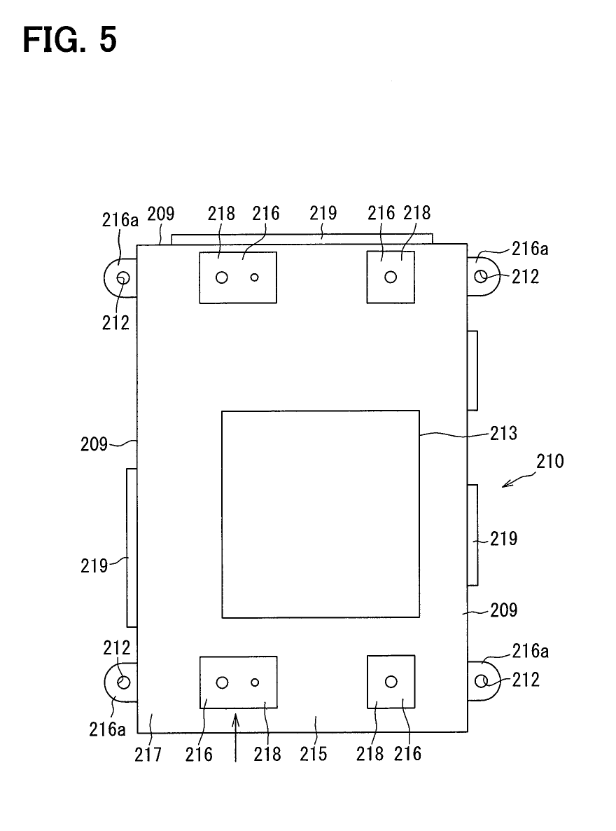

As shown in FIGS. 5 and 7, the protection plate 210 has the wall portion 219 projected from the periphery 209 toward the image display panel 10. The wall portion 219 is in contact with a lateral surface 10b of the image display panel 10. Therefore, during its assembling process, the image display panel 10 is guided with the wall portion 219, and the image display panel 10 is positioned. As shown in FIG. 4, the dimension of the wall portion 219 is determined so as not to protrude beyond the surface of the image display panel 10 in its assembled state.

As described above, the vehicle display device 100 of the present embodiment includes the multiple contact portions 216, the separated portion 217, and the multiple support portions 218. The protection plate 210 is affixed to and in contact with the circuit board 60 at the contact portions 216. The separated portion 217 is separated from the circuit board 60. The support portions 218 are in contact with and affixed to the attachment portions 221 of the image display panel 10. The electronic component 201 is mounted between the circuit board 60 and the separated portion 217. In this way, the protection plate 210 is affixed with the attachment portions 221, thereby to enhance the strength of the image display panel 10. The present configuration enables to protect the image display panel 10 from being damaged due to vibrations caused during the vehicle travels. In such a case where the image display panel 10 is large in the present embodiment, reinforcement with the protection plate 210 would be preferable. The present configuration enables to suppress display unevenness in the image display panel 10 and abnormal noise due to deformation caused in the image display panel 10.

The electronic component 201 is mounted between the circuit board 60 and the separated portion 217. Even in the configuration, in which the electronic component 201 is provided between the circuit board 60 and the image display panel 10, the protection plate 210 is enabled to protect the electronic component 201 from an external force from the side of the image display panel 10. Therefore, when the image display panel 10 is mounted onto the protection plate 210, the present configuration enables to restrict the attachment portion 221 of the image display panel 10 from making contact with the electronic component 201 of the circuit board 60. In this way, the present configuration enables to restrict the image display panel 10 from making contact with and damaging the electronic component 201 when the image display panel 10 is mounted.

Further, in the present embodiment, the device further includes the connecting portion 214 for electrically connecting the image display panel 10 with the electronic component 201. The protection plate 210 has the opening 213 through which the connecting portion 214 is inserted. In this way, the present configuration enables to connect the electronic component 201, which is located on the rear surface 10a of the image display panel 10, with the electronic component 201, which is located at the position facing the circuit board 60, by using the connecting portion 214 extending through the opening 213. Therefore, the protection plate 210 does not hinder the connection between the image display panel 10 and the circuit board 60. In this way, the present configuration enables to accommodate the connecting portion 214 between the image display panel 10 and the circuit board 60 and enables to contribute to downsizing.

Furthermore, in the present embodiment, the protection plate 210 is formed of metal having a conductivity. The circuit board 60 has the grounding electrodes 220, and the leg portions 216a are provided on the grounding electrodes 220 of the circuit board 60. The present configuration enables to electrically connect the protection plate 210 with the grounding electrode 220.

The protection plate 210 has a conductivity thereby to function as a noise shield plate for shielding noise. The present configuration enables to suppress mutual influence caused by noise between the circuit board 60 and the image display panel 10.

Further, in this embodiment, the screws 211 are inserted through the through holes 212 of the circuit board 60 and the through holes 212 of the protection plate 210, respectively. The tip ends of the screws 211 are positioned in the recessed portions 222, respectively. Therefore, the circuit board 60, the protection plate 210, and the image display panel 10 can be affixed together by using the screws 211. Further, the projected portions 223 are inserted through the through holes 212 of the protection plate 210 to position the image display panel 10 and the protection plate 210. In this way, those can be affixed by using the screws 211 after positioning by using the projected portions 223. Therefore, the present configuration enables to streamline those alignment process.

Furthermore, in the present embodiment, the protection plate 210 has the wall portion 219 projected from the periphery 209 toward the display unit. The wall portion 219 is in contact with the lateral surface 10b of the image display panel 10. Accordingly, when the protection plate 210 and the image display panel 10 are assembled together, the image display panel 10 can be guided by using the wall portion 219. The present configuration enables to streamline those alignment process between the image display panel 10 and the protection plate 210.

### Other Embodiments

Although preferred embodiments of the present disclosure have been described above, the present disclosure is not limited to the above-described embodiments, and various modifications are contemplated as exemplified below.

It should be understood that the configurations described in the above-described embodiments are example configurations, and the present disclosure is not limited to the foregoing descriptions. The scope of the present disclosure encompasses claims and various modifications of claims within equivalents thereof.

In the first embodiment described above, the protection plate 210 is formed of metal having conductivity, nevertheless, it is not limited to the material. The protection plate 210 may be made of, for example, resin.

In the first embodiment described above, the image display panel 10 also functioning as the display unit is provided together with the pointer 30, nevertheless, it is not limited to be in the configuration. For example, the entirety of the vehicle display device 100 may be formed with the image display panel 10.

In the first embodiment described above, the protection plate 210 is formed with the opening 213 through which the connecting portion 214 is inserted, nevertheless, it is not limited to the configuration. The protection plate 210 may be divided into multiple components. In this case, the protection plate 210 may be provided to a part of the circuit board 60, and the connecting portion 214 may be inserted through a portion between the components of the protection plate 210 as divided. Without forming the opening 213 in the protection plate 210, the connecting portion 214 may be drawn out from the end portion of the image display panel 10 and may be extended around the side portion of the protection plate 210. In this way, the electronic component 201 of the circuit board 60 and the image display panel 10 may be connected with each other.

In the above-described first embodiment, the portions in contact with the circuit board 60 function as the support portions 218, nevertheless, those are not limited to the configuration. The contact portion 216 and the support portion 218 may be formed separately from each other. Without causing the screws 211 to pass through the circuit board 60, the support portion 218 and the attachment portion 221 may be affixed together by using the screws 211.

In the above-described vehicle display device, the display unit 10 has a plurality of attachment portions 221 protruded from the rear surface 10a on the opposite side of the front surface. The protection plate 210 includes the plurality of contact portions 216 and 216a, the separated portion 217, and the plurality of support portions 218. The contact portions 216 and 216a are in contact with and affixed to the circuit board 60. The separated portion 217 is separated from the circuit board. The support portions 218 are in contact with and affixed to the attachment portions of the display unit. The electronic components 64 and 201 are located between the circuit board and the separated portion.

According to the present disclosure as described above, the protection plate is provided between the circuit board and the display unit. The protection plate is affixed to the circuit board. The support portions of the protection plate is in contact with and affixed to the attachment portions of the display unit. In this way, the protection plate is affixed with the attachment portions, thereby to enhance the strength of the display unit.

The electronic component is mounted between the circuit board and the separated portion. Even in the configuration, in which the electronic component is provided between the circuit board and the display unit, the protection plate is enabled to protect the electronic component from an external force from the side of the display unit. Therefore, when the display unit is mounted onto the protection plate, the present configuration enables to restrict the attachment portion of the display unit from making contact with the electronic component of the circuit board. In this way, the present configuration enables to restrict the display unit from making contact with and damaging the electronic component when the display unit is mounted.

While the present disclosure has been described with reference to the embodiments thereof, it is to be understood that the disclosure is not limited to the embodiments and constructions. The present disclosure is intended to cover various modification and equivalents. Furthermore, various combination and formation, and other combination and formation including one, more than one or less than one element may be made in the present disclosure.

What is claimed is:

1. A vehicle display device mountable on a vehicle and configured to display an image, the vehicle display device comprising:
a display unit in a plate shape and having a front surface configured to display an image;
a circuit board on which an electronic component is mounted; and
a protection plate in plate shape, the protection plate provided between the display unit and the circuit board and affixed to the circuit board, wherein
the display unit includes a plurality of attachment portions protruded from a rear surface on an opposite side of the front surface,
the protection plate includes a plurality of contact portions, a separated portion, and a plurality of support portions,
the contact portions are in contact with and affixed to the circuit board,
the separated portion is separated from the circuit board,
the support portions are in contact with and affixed to the attachment portions of the display unit, and
the electronic component is located between the circuit board and the separated portion.

2. The vehicle display device according to claim 1, further comprising:
a connecting portion electrically connecting the display unit with the electronic component, wherein
the protection plate has an opening through which the connecting portion is inserted.

3. The vehicle display device according to claim 1, wherein
the protection plate is formed of metal having a conductivity,
the circuit board has a grounding electrode, and
at least one of the contact portions is located at the grounding electrode of the circuit board.

4. The vehicle display device according to claim 1, further comprising:
a screw affixing the circuit board, the protection plate, and the display unit, wherein
a plurality of through holes is formed in the circuit board and the protection plate,
each of the attachment portions has a recessed portion or a projected portion,
the projected portion extends through the through hole of the protection plate and positions the display unit and the protection plate,
the screw extends through the through hole of the circuit board and the through hole of the protection plate, and
the screw has a tip end located in the recessed portion.

5. The vehicle display device according to claim 1, wherein
the protection plate has a wall portion projected from its periphery toward the display unit, and
the wall portion is in contact with a lateral surface of the display unit.
